(19) United States
(12) Patent Application Publication
(10) Pub. No.: US 2025/0119858 A1
(43) Pub. Date: Apr. 10, 2025

(54) REGISTRATION MANAGEMENT OF PERSONAL INTERNET OF THINGS NETWORK ELEMENTS

(71) Applicant: QUALCOMM Incorporated, San Diego, CA (US)

(72) Inventors: Kefeng ZHANG, Beijing (CN); Haris ZISIMOPOULOS, London (GB); Sebastian SPEICHER, Wallisellen (CH)

(21) Appl. No.: 18/728,666

(22) PCT Filed: Mar. 29, 2022
(86) PCT No.: PCT/CN2022/083572

§ 371 Date: Jul. 12, 2024

(51) Int. Cl. H04W 60/00; H04W 8/18; H04W 84/18

(52) U.S. Cl. CPC H04W 60/00; H04W 8/18; H04W 84/18

(57) ABSTRACT

Various aspects of the present disclosure generally relate to wireless communication. In some aspects, a personal Internet of Things (IoT) network (PIN) application server may communicate, to one or more PIN elements, signaling associated with a registration management of the one or more PIN elements, wherein the one or more PIN elements include one or more of a PIN element, a PIN element with gateway capability (PEGC), or a PIN element with management capability (PEMC). The PIN application server may update a registration with the one or more PIN elements based at least in part on the registration management of the one or more PIN elements. The PIN application server may store or updating a profile of the one or more PIN elements based at least in part on the registration management of the one or more PIN elements. Numerous other aspects are described.

### FIELD OF THE DISCLOSURE

Aspects of the present disclosure generally relate to wireless communication and to techniques and apparatuses for registration management of personal Internet of Things (IoT) network (PIN) elements.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some implementations, an apparatus of a personal Internet of Things (IoT) network (PIN) application server for wireless communication includes a memory and one or more processors, coupled to the memory, configured to: communicate, to one or more PIN elements, signaling associated with a registration management of the one or more PIN elements, wherein the one or more PIN elements include one or more of a PIN element, a PIN element with gateway capability (PEGC), or a PIN element with management capability (PEMC); update a registration with the one or more PIN elements based at least in part on the registration management of the one or more PIN elements; and store or update a profile of the one or more PIN elements based at least in part on the registration management of the one or more PIN elements.

In some implementations, an apparatus of a PEMC for wireless communication includes a memory and one or more processors, coupled to the memory, configured to: communicate, to a PIN application server, signaling associated with a registration management of the PEMC; and communicate, to the PIN application server, signaling associated with a creation of a PIN.

In some implementations, an apparatus of a PIN element for wireless communication includes a memory and one or more processors, coupled to the memory, configured to: communicate, to a PIN application server, signaling associated with a registration management of the PIN element; receive, from a PEMC via the PIN application server, a request associated with the PIN element, wherein the request is to invite the PIN element to a PIN or to expel the PIN element from the PIN; transmit, to the PEMC via the PIN application server, an indication that the request has been accepted; and receive, from the PIN application server and based at least in part on the indication that the request has been accepted, a provisioning of policy and parameter information to enforce a behavior of the PIN element.

In some implementations, an apparatus of a PEGC for wireless communication includes a memory and one or more processors, coupled to the memory, configured to: communicate, to a PIN application server, signaling associated with a registration management of the PEGC; receive, from a PEMC via the PIN application server, a request associated with the PEGC, wherein the request is to invite the PEGC to a PIN or to expel the PEGC from the PIN; transmit, to the PEMC via the PIN application server, an indication that the request has been accepted; and receive, from the PIN application server and based at least in part on the indication that the request has been accepted, a provisioning of policy and parameter information to enforce a behavior of the PEGC.

In some implementations, a method of wireless communication performed by a PIN application server includes communicating, to one or more PIN elements, signaling associated with a registration management of the one or more PIN elements, wherein the one or more PIN elements include one or more of a PIN element, a PEGC, or a PEMC; updating a registration with the one or more PIN elements based at least in part on the registration management of the one or more PIN elements; and storing or updating a profile of the one or more PIN elements based at least in part on the registration management of the one or more PIN elements.

In some implementations, a method of wireless communication performed by a PEMC includes communicating, to a PIN application server, signaling associated with a registration management of the PEMC; and communicating, to the PIN application server, signaling associated with a creation of a PIN.

In some implementations, a method of wireless communication performed by a PIN element includes communicating, to a PIN application server, signaling associated with a registration management of the PIN element; receiving, from a PEMC via the PIN application server, a request associated with the PIN element, wherein the request is to invite the PIN element to a PIN or to expel the PIN element from the PIN; transmitting, to the PEMC via the PIN application server, an indication that the request has been accepted; and receiving, from the PIN application server and based at least in part on the indication that the request has been accepted, a provisioning of policy and parameter information to enforce a behavior of the PIN element.

In some implementations, a method of wireless communication performed by a PEGC includes communicating, to a PIN application server, signaling associated with a registration management of the PEGC; receiving, from a PEMC via the PIN application server, a request associated with the PEGC, wherein the request is to invite the PEGC to a PIN or to expel the PEGC from the PIN; transmitting, to the PEMC via the PIN application server, an indication that the request has been accepted; and receiving, from the PIN application server and based at least in part on the indication that the request has been accepted, a provisioning of policy and parameter information to enforce a behavior of the PEGC.

In some implementations, a non-transitory computer-readable medium storing a set of instructions for wireless communication includes one or more instructions that, when executed by one or more processors of a PIN application server, cause the PIN application server to: communicate, to one or more PIN elements, signaling associated with a registration management of the one or more PIN elements, wherein the one or more PIN elements include one or more of a PIN element, a PEGC, or a PEMC; update a registration with the one or more PIN elements based at least in part on the registration management of the one or more PIN elements; and store or updating a profile of the one or more PIN elements based at least in part on the registration management of the one or more PIN elements.

In some implementations, a non-transitory computer-readable medium storing a set of instructions for wireless communication includes one or more instructions that, when executed by one or more processors of a PEMC, cause the PEMC to: communicate, to a PIN application server, signaling associated with a registration management of the PEMC; and communicate, to the PIN application server, signaling associated with a creation of a PIN.

In some implementations, a non-transitory computer-readable medium storing a set of instructions for wireless communication includes one or more instructions that, when executed by one or more processors of a PIN element, cause the PIN element to: communicate, to a PIN application server, signaling associated with a registration management of the PIN element; receive, from a PEMC via the PIN application server, a request associated with the PIN element, wherein the request is to invite the PIN element to a PIN or to expel the PIN element from the PIN; transmit, to the PEMC via the PIN application server, an indication that the request has been accepted; and receive, from the PIN application server and based at least in part on the indication that the request has been accepted, a provisioning of policy and parameter information to enforce a behavior of the PIN element.

In some implementations, a non-transitory computer-readable medium storing a set of instructions for wireless communication includes one or more instructions that, when executed by one or more processors of a PEGC, cause the PEGC to: communicate, to a PIN application server, signaling associated with a registration management of the PEGC; receive, from a PEMC via the PIN application server, a request associated with the PEGC, wherein the request is to invite the PEGC to a PIN or to expel the PEGC from the PIN; transmit, to the PEMC via the PIN application server, an indication that the request has been accepted; and receive, from the PIN application server and based at least in part on the indication that the request has been accepted, a provisioning of policy and parameter information to enforce a behavior of the PEGC.

In some implementations, an apparatus for wireless communication includes means for communicating, to one or more PIN elements, signaling associated with a registration management of the one or more PIN elements, wherein the one or more PIN elements include one or more of a PIN element, a PEGC, or a PEMC; means for updating a registration with the one or more PIN elements based at least in part on the registration management of the one or more PIN elements; and means for storing or updating a profile of the one or more PIN elements based at least in part on the registration management of the one or more PIN elements.

In some implementations, an apparatus for wireless communication includes means for communicating, to a PIN application server, signaling associated with a registration management of the apparatus; and means for communicating, to the PIN application server, signaling associated with a creation of a PIN.

In some implementations, an apparatus for wireless communication includes means for communicating, to a PIN application server, signaling associated with a registration management of the apparatus; means for receiving, from a PEMC via the PIN application server, a request associated with the apparatus, wherein the request is to invite the apparatus to a PIN or to expel the apparatus from the PIN; means for transmitting, to the PEMC via the PIN application server, an indication that the request has been accepted; and means for receiving, from the PIN application server and based at least in part on the indication that the request has been accepted, a provisioning of policy and parameter information to enforce a behavior of the apparatus.

In some implementations, an apparatus for wireless communication includes means for communicating, to a PIN application server, signaling associated with a registration management of the apparatus; means for receiving, from a PEMC via the PIN application server, a request associated with the apparatus, wherein the request is to invite the apparatus to a PIN or to expel the apparatus from the PIN; means for transmitting, to the PEMC via the PIN application server, an indication that the request has been accepted; and means for receiving, from the PIN application server and based at least in part on the indication that the request has been accepted, a provisioning of policy and parameter information to enforce a behavior of the apparatus.

Aspects generally include a method, apparatus, system, computer program product, non-transitory computer-readable medium, PIN application server, PEMC, PIN element, PEGC, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of a disaggregated base station architecture, in accordance with the present disclosure.

FIG. 4 is a diagram illustrating an example of a personal Internet of Things (IoT) network (PIN) architecture in a fifth generation system (5GS), in accordance with the present disclosure.

FIG. 5 is a diagram illustrating an example associated with registration management of PIN elements, in accordance with the present disclosure.

FIGS. 6-9 are diagrams illustrating example processes associated with registration management of PIN elements, in accordance with the present disclosure.

FIGS. 10-13 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

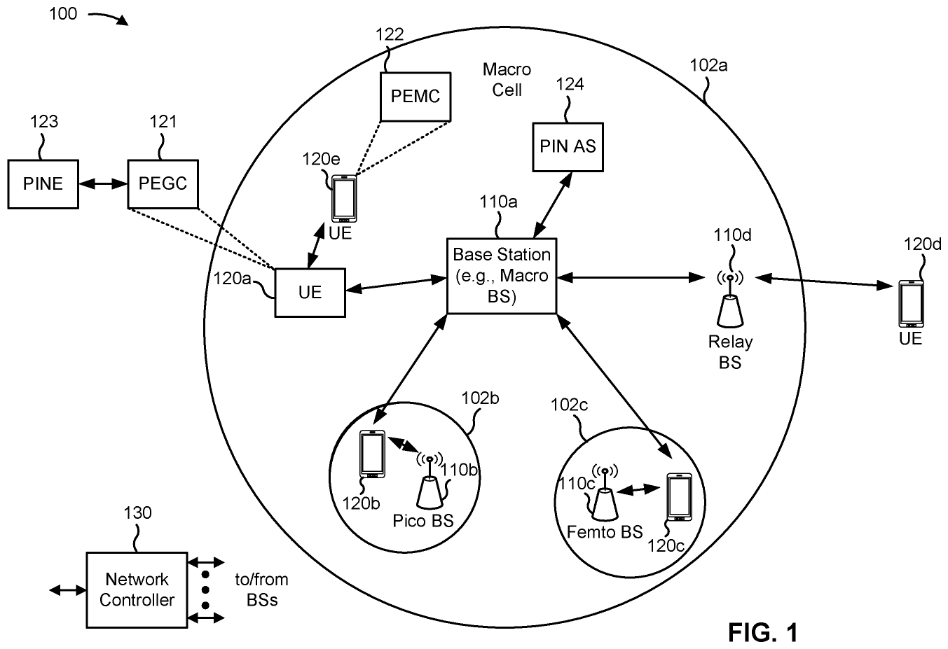

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some aspects, the term “base station” (e.g., the base station 110) or “network entity” may refer to an aggregated base station, a disaggregated base station, an integrated access and backhaul (IAB) node, a relay node, and/or one or more components thereof. For example, in some aspects, “base station” or “network entity” may refer to a central unit (CU), a distributed unit (DU), a radio unit (RU), a Near-Real Time (Near-RT) RAN Intelligent Controller (RIC), or a Non-Real Time (Non-RT) RIC, or a combination thereof. In some aspects, the term “base station” or “network entity” may refer to one device configured to perform one or more functions, such as those described herein in connection with the base station 110. In some aspects, the term “base station” or “network entity” may refer to a plurality of devices configured to perform the one or more functions. For example, in some distributed systems, each of a number of different devices (which may be located in the same geographic location or in different geographic locations) may be configured to perform at least a portion of a function, or to duplicate performance of at least a portion of the function, and the term “base station” or “network entity” may refer to any one or more of those different devices. In some aspects, the term “base station” or “network entity” may refer to one or more virtual base stations and/or one or more virtual base station functions. For example, in some aspects, two or more base station functions may be instantiated on a single device. In some aspects, the term “base station” or “network entity” may refer to one of the base station functions and not another. In this way, a single device may include more than one base station.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHZ) and FR2 (24.25 GHz-52.6 GHz). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHZ), and FR5 (114.25 GHZ-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHZ, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, as described in more detail elsewhere herein, a personal IoT network (PIN) application server (e.g., PIN AS 124) may communicate, to one or more PIN elements, signaling associated with a registration management of the one or more PIN elements, wherein the one or more PIN elements include one or more of a PIN element, a PIN element with gateway capability (PEGC), or a PIN element with management capability (PEMC); update a registration with the one or more PIN elements based at least in part on the registration management of the one or more PIN elements; and store or updating a profile of the one or more PIN elements based at least in part on the registration management of the one or more PIN elements. Additionally, or alternatively, the PIN application server may perform one or more other operations described herein.

In some aspects, as described in more detail elsewhere herein, a PEMC (e.g., PEMC 122) may communicate, to a PIN application server, signaling associated with a registration management of the PEMC; and communicate, to the PIN application server, signaling associated with a creation of a PIN. Additionally, or alternatively, the PEMC may perform one or more other operations described herein.

In some aspects, as described in more detail elsewhere herein, a PIN element (e.g., PINE 123) may communicate, to a PIN application server, signaling associated with a registration management of the PIN element; receive, from a PEMC via the PIN application server, a request associated with the PIN element, wherein the request is to invite the PIN element to a PIN or to expel the PIN element from the PIN; transmit, to the PEMC via the PIN application server, an indication that the request has been accepted; and receive, from the PIN application server and based at least in part on the indication that the request has been accepted, a provisioning of policy and parameter information to enforce a behavior of the PIN element. Additionally, or alternatively, the PIN element may perform one or more other operations described herein.

In some aspects, as described in more detail elsewhere herein, a PEGC (e.g., PEGC 121) may communicate, to a PIN application server, signaling associated with a registration management of the PEGC; receive, from a PEMC via the PIN application server, a request associated with the PEGC, wherein the request is to invite the PEGC to a PIN or to expel the PEGC from the PIN; transmit, to the PEMC via the PIN application server, an indication that the request has been accepted; and receive, from the PIN application server and based at least in part on the indication that the request has been accepted, a provisioning of policy and parameter information to enforce a behavior of the PEGC. Additionally, or alternatively, the PEGC may perform one or more other operations described herein.

As indicated above, FIG. 1 is provided as an example. Other examples may differ from what is described with regard to FIG. 1.

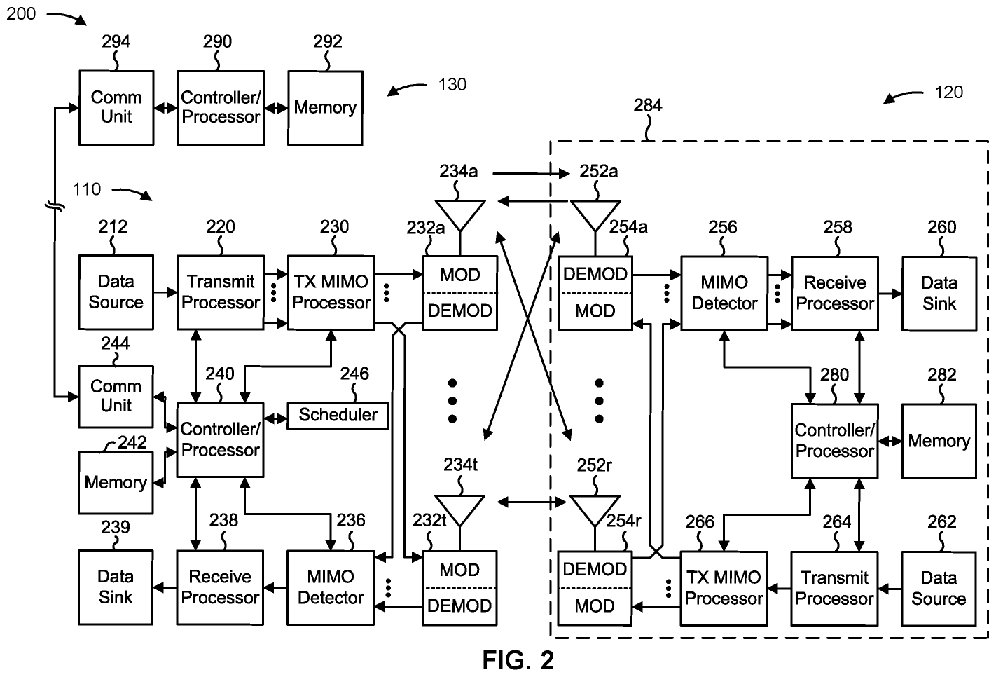

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

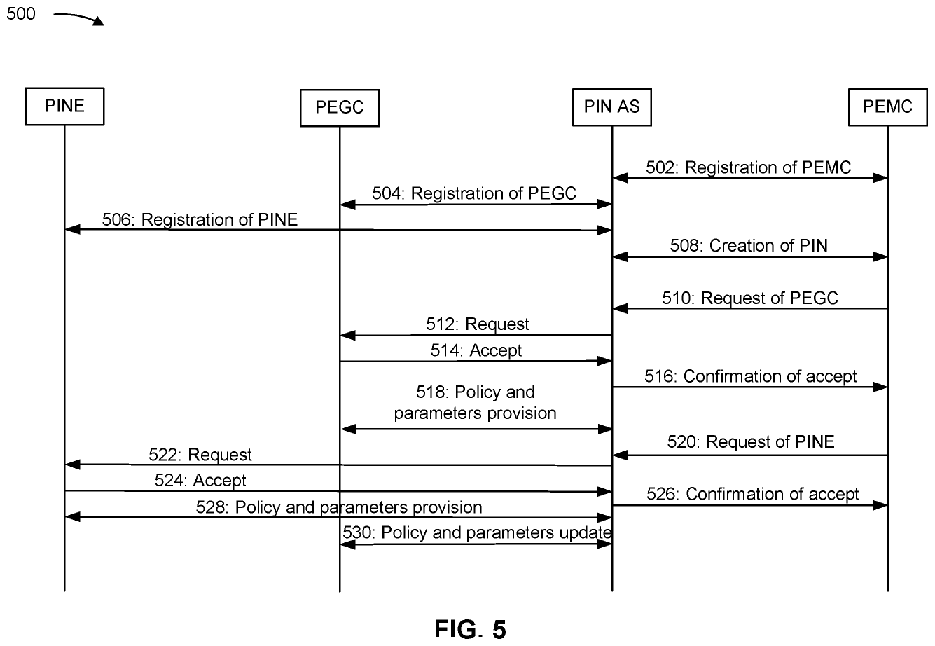

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 5-13).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 5-13).

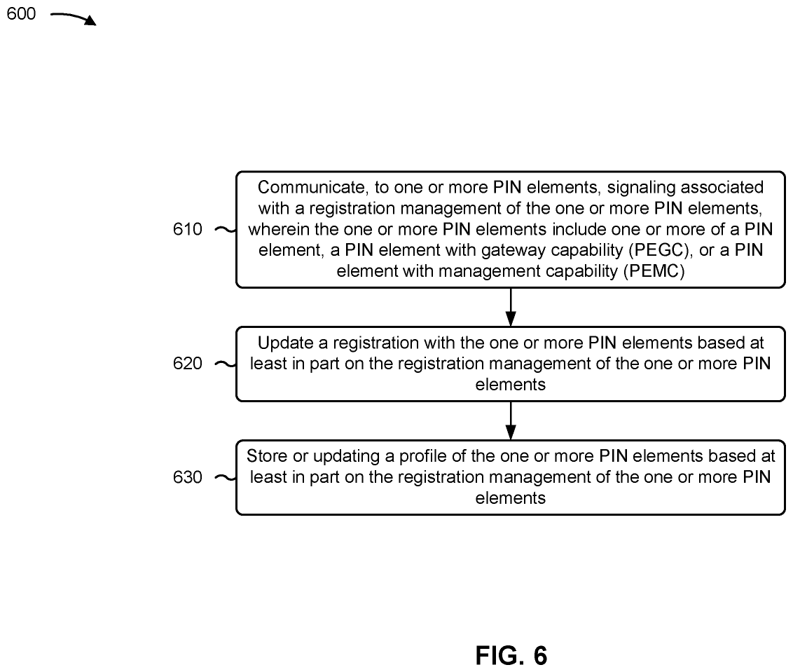

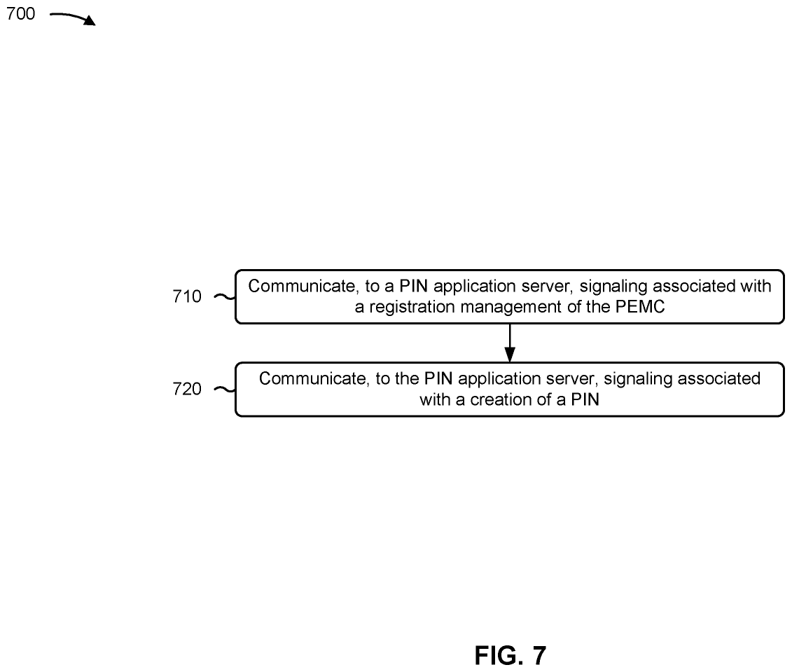

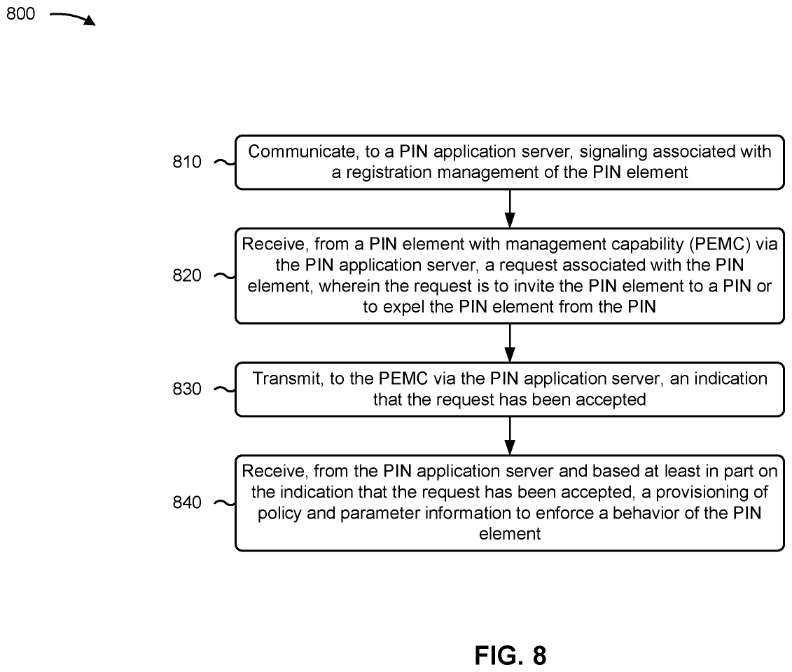

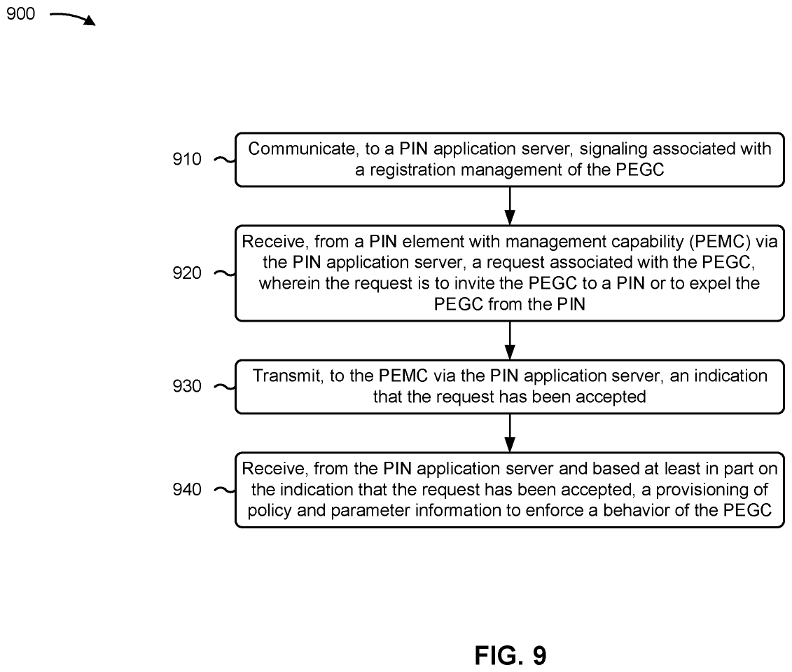

The controller/processor 240 of the base station 110, the controller/processor 280 of the UE 120, and/or any other component(s) of FIG. 2 may perform one or more techniques associated with registration management of PIN elements, as described in more detail elsewhere herein. In some aspects, the PIN element, the PEGC, and/or the PEMC described herein is the UE 120, is included in the UE 120, or includes one or more components of the UE 120 shown in FIG. 2. In some aspects, the PIN application server described herein is the base station 110, is included in the base station 110, or includes one or more components of the base station 110 shown in FIG. 2. For example, the controller/processor 240 of the base station 110, the controller/processor 280 of the UE 120, and/or any other component(s) of FIG. 2 may perform or direct operations of, for example, process 600 of FIG. 6, process 700 of FIG. 7, process 800 of FIG. 8, process 900 of FIG. 9, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 600 of FIG. 6, process 700 of FIG. 7, process 800 of FIG. 8, process 900 of FIG. 9, and/or other processes as described herein. In some examples, executing instructions may include running the instructions, converting the instructions, compiling the instructions, and/or interpreting the instructions, among other examples.

In some aspects, a PIN application server (e.g., PIN AS 124) includes means for communicating, to one or more PIN elements, signaling associated with a registration management of the one or more PIN elements, wherein the one or more PIN elements include one or more of a PIN element, a PEGC, or a PEMC; means for updating a registration with the one or more PIN elements based at least in part on the registration management of the one or more PIN elements; and/or means for storing or updating a profile of the one or more PIN elements based at least in part on the registration management of the one or more PIN elements. In some aspects, the means for the to perform operations described herein may include, for example, one or more of transmit processor 220, TX MIMO processor 230, modem 232, antenna 234, MIMO detector 236, receive processor 238, controller/processor 240, memory 242, or scheduler 246.

In some aspects, a PEMC (e.g., PEMC 122) includes means for communicating, to a PIN application server, signaling associated with a registration management of the PEMC; and/or means for communicating, to the PIN application server, signaling associated with a creation of a PIN. In some aspects, the means for the to perform operations described herein may include, for example, one or more of antenna 252, modem 254, MIMO detector 256, receive processor 258, transmit processor 264, TX MIMO processor 266, controller/processor 280, or memory 282.

In some aspects, a PIN element (e.g., PINE 123) includes means for communicating, to a PIN application server, signaling associated with a registration management of the PIN element; means for receiving, from a PEMC via the PIN application server, a request associated with the PIN element, wherein the request is to invite the PIN element to a PIN or to expel the PIN element from the PIN; means for transmitting, to the PEMC via the PIN application server, an indication that the request has been accepted; and/or means for receiving, from the PIN application server and based at least in part on the indication that the request has been accepted, a provisioning of policy and parameter information to enforce a behavior of the PIN element. In some aspects, the means for the to perform operations described herein may include, for example, one or more of antenna 252, modem 254, MIMO detector 256, receive processor 258, transmit processor 264, TX MIMO processor 266, controller/processor 280, or memory 282.

In some aspects, a PEGC (e.g., PEGC 121) includes means for communicating, to a PIN application server, signaling associated with a registration management of the PEGC; means for receiving, from a PEMC via the PIN application server, a request associated with the PEGC, wherein the request is to invite the PEGC to a PIN or to expel the PEGC from the PIN; means for transmitting, to the PEMC via the PIN application server, an indication that the request has been accepted; and/or means for receiving, from the PIN application server and based at least in part on the indication that the request has been accepted, a provisioning of policy and parameter information to enforce a behavior of the PEGC. In some aspects, the means for the to perform operations described herein may include, for example, one or more of antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

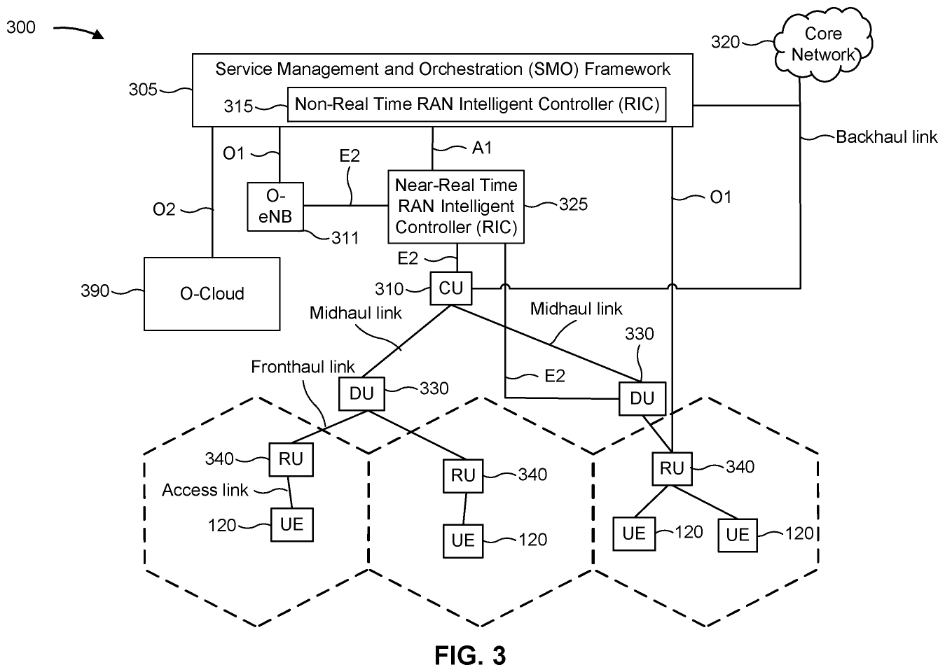

FIG. 3 is a diagram illustrating an example 300 of a disaggregated base station architecture, in accordance with the present disclosure.

Deployment of communication systems, such as 5G NR systems, may be arranged in multiple manners with various components or constituent parts. In a 5G NR system, or network, a network node, a network entity, a mobility element of a network, a RAN node, a core network node, a network element, or a network equipment, such as a base station (BS, e.g., base station 110), or one or more units (or one or more components) performing base station functionality, may be implemented in an aggregated or disaggregated architecture. For example, a BS (such as a Node B (NB), eNB, NR BS, 5G NB, access point (AP), a TRP, a cell, or the like) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more CUs, one or more DUs, or one or more RUs). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual centralized unit (VCU), a virtual distributed unit (VDU), or a virtual radio unit (VRU).

Base station-type operation or network design may consider aggregation characteristics of base station functionality. For example, disaggregated base stations may be utilized in an IAB network, an O-RAN (such as the network configuration sponsored by the O-RAN Alliance), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

The disaggregated base station architecture shown in FIG. 3 may include one or more CUs 310 that can communicate directly with a core network 320 via a backhaul link, or indirectly with the core network 320 through one or more disaggregated base station units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as an F1 interface. The DUs 330 may communicate with one or more RUs 340 via respective fronthaul links. The RUs 340 may communicate with respective UEs 120 via one or more radio frequency (RF) access links. In some implementations, the UE 120 may be simultaneously served by multiple RUs 340.

Each of the units (e.g., the CUS 310, the DUs 330, the RUs 340), as well as the Near-RT RICs 325, the Non-RT RICs 315, and the SMO Framework 305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (e.g., Central Unit-User Plane (CU-UP)), control plane functionality (e.g., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3GPP. In some aspects, the DU 330 may further host one or more low-PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 120. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340 and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via 01) or via creation of RAN management policies (such as A1 policies).

As indicated above, FIG. 3 is provided as an example. Other examples may differ from what is described with regard to FIG. 3.

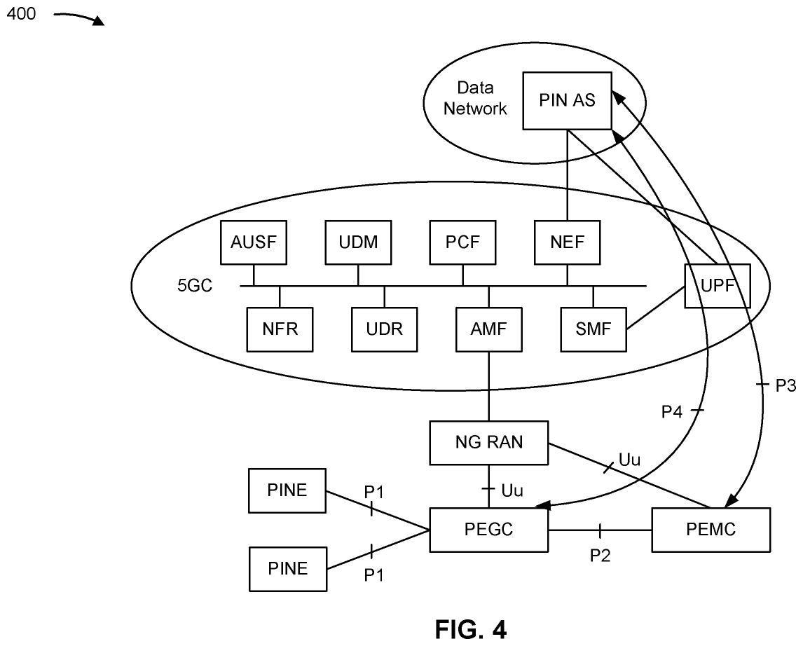

FIG. 4 is a diagram illustrating an example 400 of a PIN architecture in a fifth generation system (5GS), in accordance with the present disclosure.

As shown in FIG. 4, the PIN architecture may include one or more PIN elements (PINEs). The PIN element may be a UE or a device without a 3GPP capability, such as a smart watch or smart glasses. The PIN element may communicate with a PEGC. The PEGC may be a first UE. The PIN element may communicate with the PEGC via a P1 reference point between the PIN element and the PEGC. The P1 reference point may be based at least in part on a non-3GPP access (e.g., WiFi or Bluetooth). The PEGC may communicate with a PEMC. The PEMC may be a second UE. The PEGC may communicate with the PEMC via a P2 reference point between the PEGC and the PEMC. The P2 reference point may be based at least in part on a non-3GPP access (e.g., WiFi or Bluetooth) or a 5G ProSe direction communication (e.g., a sidelink communication). The PEGC may communicate with a Next Generation radio access network (NG RAN) via a Uu interface between the PEGC and the NG RAN. The PEMC may communicate with the NG RAN via a Uu interface between the PEMC and the NG RAN.

The NG RAN may communicate with a 5G core network (5GC). The 5GC may include an authentication server function (AUSF), a unified data management (UDM), a policy control function (PCF), a network exposure function (NEF), a network function (NF) repository function (NRF), a unified data repository (UDR), an access and mobility management function (AMF), a session management function (SMF), and a user plane function (UPF). The NEF and the UPF may be able to communicate with a PIN application server (PIN AS), which may be associated with a data network. The PEMC may communicate with the PIN application server via a P3 reference point between the PEMC and the PIN application server. The P3 reference point may be based at least in part on a direct user plane path to the 5GS, a relay path via the PEGC, or another communication path via the Internet. The PEGC may communicate with the PIN application server via a P4 reference point between the PEGC and the PIN application server. The P4 reference point may be based at least in part on a user plane path between the PEGC and the 5GS.

As indicated above, FIG. 4 is provided as an example. Other examples may differ from what is described with regard to FIG. 4.

A PIN architecture in a 5GS may include one or more PIN elements, a PEGC, a PEMC, and/or a PIN application server. However, mechanisms for managing the PIN and the one or more PIN elements may not be defined. A management of the PIN may involve registering or deregistering one or more PIN elements. Further, mechanisms for authorizing the PIN may not be defined. An authorization of the PIN may involve adding one or more PIN elements to the PIN and/or removing one or more PIN elements from the PIN. Without definitions for the management and the authorization, a functionality of the PIN architecture may be limited.

In various aspects of techniques and apparatuses described herein, a PIN application server may perform a management of a PIN, a management of PIN elements, and an authorization for the PIN. The PIN application server may perform a registration of PIN elements (e.g., a PIN element, a PEGC, and/or a PEMC) to the PIN, which may involve an authentication and an authorization of the PIN elements, an allocation of PIN element IDs, and/or a creation of a PIN profile. The PIN application server may communicate with PIN elements via the Internet. After a successful registration, the PEMC may transmit a request to the PIN application server to create the PIN, and a PIN ID may be assigned by the PIN application server to the PEMC.

In some aspects, the PEMC may transmit a request to the PEGC via the PIN application server (e.g., an invitation request), and the PEGC may transmit a response (e.g., an invitation acceptance) to the PEMC via the PIN application server. The PIN application server may update storage data of the PIN profile and PEGC context accordingly, and the PIN application server may provision PIN specific application data to a 5GC (e.g., a PCF or a UDR) for policy control. The PIN application server may transmit policy and parameter information to the PEGC for configuring PIN communication. In some aspects, the PEMC may transmit a request to the PIN element via the PIN application server (e.g., an invitation request), and the PIN element may transmit a response (e.g., an invitation acceptance) to the PEMC via the PIN application server. The PIN application server may update storage data of the PIN profile and PIN element context accordingly. The PIN application server may transmit policy and parameter information to the PIN element for configuring PIN communication.

In some aspects, when an association with the PEGC and PIN elements are requested, the PIN application server may update context data associated with the PEGC and the PIN elements, and the PIN application server may provision PIN specific application data to the 5GC for policy control in the PEGC. The PIN application server may then transmit policy and parameter information to the associated PEGC and PIN elements for configuring PIN communications.

FIG. 5 is a diagram illustrating an example 500 associated with registration management of PIN elements, in accordance with the present disclosure. As shown in FIG. 5, example 500 includes communication between a PIN element (e.g., PINE 123), a PEGC (e.g., PEGC 121, which may be associated with UE 120a), a PEMC (e.g., PEMC 122, which may be associated with UE 120e), and a PIN application server (PIN AS 124). In some aspects, the PIN element, the PEGC, the PEMC, and the PIN application server may be included in a wireless network, such as wireless network 100.

As shown by reference number 502, the PIN application server may communicate, to the PEMC, signaling associated with a registration management of the PEMC. The PEMC may communicate, to the PIN application server, the signaling associated with the registration management of the PEMC. The registration management may include a registration of the PEMC or a deregistration of the PEMC. The registration management of the PEMC may be based at least in part on an authentication of the PEMC and an access authorization of the PEMC.

As shown by reference number 504, the PIN application server may communicate, to the PEGC, signaling associated with a registration management of the PEGC. The PEGC may communicate, to the PIN application server, the signaling associated with the registration management of the PEGC. The registration management may include a registration of the PEGC or a deregistration of the PEGC. The registration management of the PEGC may be based at least in part on an authentication of the PEGC and an access authorization of the PEGC.

As shown by reference number 506, the PIN application server may communicate, to the PIN element, signaling associated with a registration management of the PIN element. The PIN element may communicate, to the PIN application server, the signaling associated with the registration management of the PIN element. The registration management may include a registration of the PIN element or a deregistration of the PIN element. The registration management of the PIN element may be based at least in part on an authentication of the PIN element and an access authorization of the PIN element. Further, the PIN element may be associated with a PIN, or the PIN element may be included in the PIN.

In some aspects, the PIN application may communicate with one or more PIN elements. As used herein, “one or more PIN elements” may refer to the PIN element, the PEGC, and/or the PEMC. In other words, “one or more PIN elements” may refer to a collective group of PIN elements, which may include the PIN element, the PEGC, and/or the PEMC.

In some aspects, the PIN application server may communicate, to the one or more PIN elements, signaling associated with a registration management of the one or more PIN elements. The one or more PIN elements may include the PIN element, the PEGC, and/or the PEMC. In some aspects, the PIN application server may update a registration with the one or more PIN elements based at least in part on the registration management of the one or more PIN elements.

In some aspects, the PIN application server may store or update a profile of the one or more PIN elements based at least in part on the registration management of the one or more PIN elements. The profile of the one or more PIN elements may indicate a device identifier (ID), a device name, a MAC address, a Bluetooth ID, a generic public subscription identifier (GPSI) of a UE, security related information, a device type, device communication capabilities, and/or device services capabilities.

In some aspects, the PIN application server may communicate, to the one or more PIN elements, signaling associated with an updated registration management. The updated registration management may be in a periodic manner for the one or more PIN elements to be reachable to the PIN application server. The updated registration management may be to update a status of the one or more PIN elements. The updated registration management may be to update a communication path associated with the one or more PIN elements. The updated registration management may be to update capabilities or parameters of the one or more PIN elements.

In some aspects, the PIN application server may maintain device context data of the one or more PIN elements based at least in part on the registration management. The device context data may indicate an associated PIN ID, an indication of associated PIN elements, a device state, allocated Internet protocol (IP) addresses, authorized communication paths, and/or authorized services.

In some aspects, the registration management may be used to register or deregister the PEMC, the PEGC, and/or the PIN element with the PIN application server, and to maintain user context in the network. An initial registration procedure may involve an execution of an authentication and access authorization for the PEMC, the PEGC, and/or the PIN element, which may be based at least in part on a configuration of an owner of the PEMC, the PEGC, and/or the PIN element (e.g., an owner of the devices). After the registration and when application, the PEMC, the PEGC, and/or the PIN element may update its registration with the PIN application server. The registration of the PEMC, the PEGC, and/or the PIN element may be updated periodically, in order for the PEMC, the PEGC, and/or the PIN element to remain reachable to the PIN application server. The registration of the PEMC, the PEGC, and/or the PIN element may be updated in order to update a status of the PEMC, the PEGC, and/or the PIN element. The registration of the PEMC, the PEGC, and/or the PIN element may be updated in order to update a communication path of the PEMC, the PEGC, and/or the PIN element. The registration of the PEMC, the PEGC, and/or the PIN element may be updated in order to update capabilities and/or parameters of the PEMC, the PEGC, and/or the PIN element.

In some aspects, the profile of the PIN element, the PEGC, and/or the PEMC may be stored or updated by the PIN application server after the registration is successful. The profile of the PIN element, the PEGC, and/or the PEMC (e.g., a device profile) may indicate the device ID, the device name, the MAC address, the Bluetooth ID, the GPSI of the UE, the security related information, the device type (e.g., PIN element, PEMC, or PEGC), the device communication capabilities, and/or the device services capabilities. In some aspects, the device context data of the PIN element or the PEGC of the PIN may indicate the associated PIN ID, associated PEGCs or associated PIN elements, the device state, the allocated IP addresses (e.g., an IP version 6 (IPv6) prefix), the authorized communication paths, and/or the authorized service.

As shown by reference number 508, the PIN application server may communicate, to the PEMC, signaling associated with a creation of the PIN. The PEMC may communicate, to the PIN application server, the signaling associated with the creation of the PIN. For example, the PIN application server may receive, from the PEMC, a request to create the PIN. The PIN application server may transmit, to the PEMC and based at least in part on the request, an indication of the PIN ID. In other words, the PEMC may transmit the request to create the PIN to the PIN application server, and the PEMC may receive the indication of the PIN ID from the PIN application server based at least in part on the request. The PIN ID may be assigned by the PIN application server to the PEMC, and the PEMC may be authorized to manage the PIN. In some aspects, the PIN application server may store a PIN profile associated with the PIN, and the PIN application server may synchronize the PIN profile with the PEMC. The PIN profile may indicate a PIN state, a list of serving PEMCs, a list of serving PEGCs, a list of PIN elements, and/or a validity duration and a time validity of the PIN and the PIN element.

In some aspects, the PEMC may be registered by the PIN application server, and the PEMC may be authorized to manage the PIN. A user of the PEMC may initiate the request to create the PIN, for example, via a P3 reference point with the PIN application server. The PIN ID may be allocated by the PIN application server. An optional PIN name may be allocated by the user of the PEMC. The PIN profile and context data of the PIN may be stored in the PIN application server and synchronized with the PEMC. The PIN profile may store context data, such as the PIN state (e.g., active or inactive), the list of serving PEMCs, the list of serving PEGCs, the list of PIN elements, and/or the validity duration and the time validity of the PIN and the PIN element. The list of serving PEMCs may indicate, for a specific PEMC, a PEMC ID, a PEMC state, and/or a GPSI and public land mobile network (PLMN) ID. The list of serving PEGCs may indicate, for a specific PEGC, a PEGC ID, a PEGC state, and/or a GPSI and PLMN ID. The list of PIN elements may indicate, for a specific PIN element, a PIN element ID, a PIN element state, a MAC address, a Bluetooth ID, a GPSI and PLMN ID, and/or an association with the PEGC and other PIN elements.

As shown by reference number 510, the PIN application server may receive, from the PEMC, a request associated with the PEGC. The request may be to invite the PEGC to the PIN or to expel the PEGC from the PIN. As shown by reference number 512, the PIN application server may transmit the request to the PEGC. In other words, the PEMC may transmit, to the PEGC via the PIN application server, the request associated with the PEGC. The PEGC may receive, from the PEMC via the PIN application server, the request associated with the PEGC. As shown by reference number 514, the PIN application server may receive, from the PEGC, an indication that the request has been accepted. As shown by reference number 516, the PIN application server may transmit, to the PEMC, the indication that the request has been accepted. In other words, the PEMC may receive, from the PEGC via the PIN application server, the indication that the request has been accepted, where the request may be associated with the PEGC. The PEGC may transmit, to the PEMC via the PIN application server, the indication that the request has been accepted. As shown by reference number 518, the PIN application server may update the PIN profile associated with the PIN based at least in part on the request being accepted. A policy and parameters may be provisioned to the PEGC based at least in part on a reference point between the PIN application server and the PEGC. The PEGC may receive, from the PIN application server and based at least in part on the indication that the request has been accepted, a provisioning of policy and parameter information to enforce a behavior of the PEGC.

In some aspects, the PEMC may invite or expel the PEGC in the PIN, and the PEGC may request to join or leave the PIN. Signaling (e.g., requests and acceptances of the requests) between the PEMC and the PEGC may be routed to the PIN application server for authorization. After a successful authorization, the PIN application server may update the PIN profile and modify context data of the involved PEGC. Further, the policy and parameters may be provisioned to the PEGC, via a P4 reference point between the PEGC and the PIN application server, to enforce a behavior of the PEGC.

As shown by reference number 520, the PIN application server may receive, from the PEMC, a request associated with the PIN element. The request may be to invite the PIN element to the PIN or to expel the PIN element from the PIN. As shown by reference number 522, the PIN application server may transmit the request to the PIN element. In other words, the PEMC may transmit, to the PIN element via the PIN application server, the request associated with the PIN element. The PIN element may receive, from the PEMC via the PIN application server, the request associated with the PIN element. As shown by reference number 524, the PIN application server may receive, from the PIN element, an indication that the request has been accepted. As shown by reference number 526, the PIN application server may transmit, to the PEMC, the indication that the request has been accepted. In other words, the PEMC may receive, from the PIN element via the PIN application server, the indication that the request has been accepted, where the request may be associated with the PIN element. The PIN element may transmit, to the PEMC via the PIN application server, the indication that the request has been accepted. As shown by reference number 528, the PIN application server may update the PIN profile associated with the PIN based at least in part on the request being accepted. A policy and parameters may be provisioned to the PIN element based at least in part on a reference point between the PIN application server and the PIN element. The PIN element may receive, from the PIN application server and based at least in part on the indication that the request has been accepted, a provisioning of policy and parameter information to enforce a behavior of the PIN element.

In some aspects, the PEMC may invite or expel the PIN element in the PIN, and the PIN element may request to join or leave the PIN. Signaling (e.g., requests and acceptances of the requests) between the PEMC and the PIN element may be routed to the PIN application server for authorization. After a successful authorization, the PIN application server may update the PIN profile and modify context data of the involved PIN element. Further, the policy and parameters may be provisioned to the PIN element, via a P1 reference point between the PIN element and the PEGC, to enforce a behavior of the PIN element.

As shown by reference number 530, the PIN application server may provision, based at least in part on a policy of a mobile operator, PIN related information to a 5GC for policy control or subscription management. The PIN application server may transmit, to the PEGC and/or the PIN element, policy and parameter update information based at least in part on provisioning the PIN related information to the 5GC. In other words, according to the policy of the mobile operator, the PIN application server may provision the PIN related information to the 5GC (e.g., an NEF, PCF, UDR, or UDM) for the policy control or the subscription management.

In some aspects, the management of the PIN and the PIN elements, and the authorization for the PIN, may impact certain nodes in the 5GC. The PCF may include a function to provision a UE and the SMF with certain parameters in order to support PIN communications. The UDR may perform a storage of PIN services parameters. The NEF may support additional PIN service parameters, which may be for PIN application functions to provide service specific information to a 3GPP network.

As indicated above, FIG. 5 is provided as an example. Other examples may differ from what is described with regard to FIG. 5.

FIG. 6 is a diagram illustrating an example process 600 performed, for example, by a PIN application server, in accordance with the present disclosure. Example process 600 is an example where the PIN application server (e.g., PIN AS 124) performs operations associated with registration management of PIN elements.

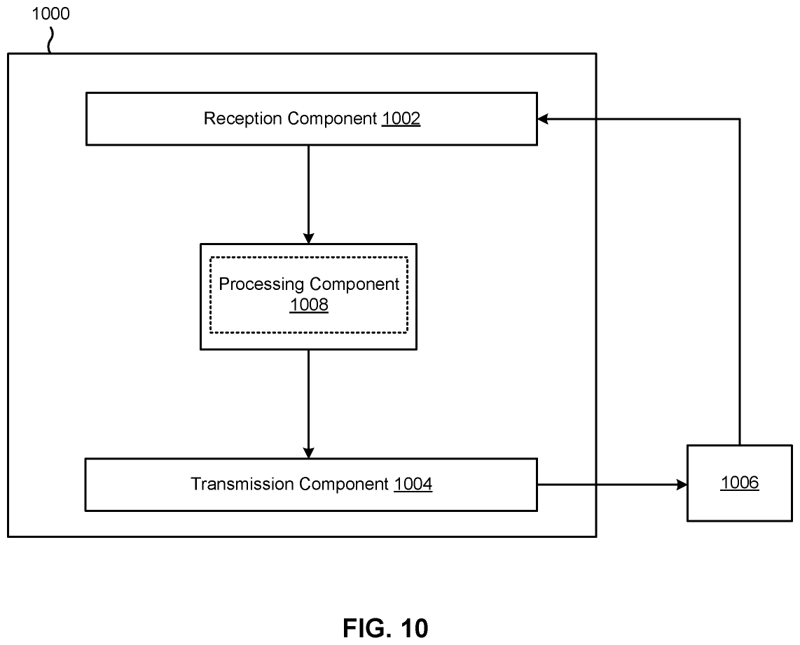

As shown in FIG. 6, in some aspects, process 600 may include communicating, to one or more PIN elements, signaling associated with a registration management of the one or more PIN elements, wherein the one or more PIN elements include one or more of a PIN element, a PEGC, or a PEMC (block 610). For example, the PIN application server (e.g., using reception component 1002 and/or transmission component 1004, depicted in FIG. 10) may communicate, to one or more PIN elements, signaling associated with a registration management of the one or more PIN elements, wherein the one or more PIN elements include one or more of a PIN element, a PEGC, or a PEMC, as described above.

As further shown in FIG. 6, in some aspects, process 600 may include updating a registration with the one or more PIN elements based at least in part on the registration management of the one or more PIN elements (block 620). For example, the PIN application server (e.g., using processing component 1008, depicted in FIG. 10) may update a registration with the one or more PIN elements based at least in part on the registration management of the one or more PIN elements, as described above.

As further shown in FIG. 6, in some aspects, process 600 may include storing or updating a profile of the one or more PIN elements based at least in part on the registration management of the one or more PIN elements (block 630). For example, the PIN application server (e.g., using processing component 1008, depicted in FIG. 10) may store or updating a profile of the one or more PIN elements based at least in part on the registration management of the one or more PIN elements, as described above.

Process 600 may include additional aspects, such as any single aspect or any combination of aspects described below and/or in connection with one or more other processes described elsewhere herein.

In a first aspect, the registration management includes a registration of the one or more PIN elements or a deregistration of the one or more PIN elements.

In a second aspect, alone or in combination with the first aspect, the registration management of the one or more PIN elements is based at least in part on an authentication of the one or more PIN elements and an access authorization of the one or more PIN elements.

In a third aspect, alone or in combination with one or more of the first and second aspects, process 600 includes communicating, to the one or more PIN elements, signaling associated with an updated registration management, wherein the updated registration management is in a periodic manner for the one or more PIN elements to be reachable to the PIN application server, to update a status of the one or more PIN elements, to update a communication path associated with the one or more PIN elements, or to update capabilities or parameters of the one or more PIN elements.

In a fourth aspect, alone or in combination with one or more of the first through third aspects, the profile of the one or more PIN elements indicates one or more of a device ID, a device name, a media access control address, a Bluetooth ID, a GPSI of a UE, security related information, a device type, device communication capabilities, or device services capabilities.

In a fifth aspect, alone or in combination with one or more of the first through fourth aspects, process 600 includes maintaining device context data of the one or more PIN elements based at least in part on the registration management, wherein the device context data indicates one or more of an associated PIN identifier, an indication of associated PIN elements, a device state, allocated IP addresses, authorized communication paths, or authorized services.

In a sixth aspect, alone or in combination with one or more of the first through fifth aspects, process 600 includes communicating, to the PEMC, signaling associated with a creation of a PIN.

In a seventh aspect, alone or in combination with one or more of the first through sixth aspects, process 600 includes receiving, from the PEMC, a request to create the PIN, and transmitting, to the PEMC and based at least in part on the request, an indication of a PIN ID, wherein the PIN ID is assigned by the PIN application server to the PEMC, and the PEMC is authorized to manage the PIN.

In an eighth aspect, alone or in combination with one or more of the first through seventh aspects, process 600 includes storing a PIN profile associated with the PIN and synchronizing the PIN profile with the PEMC, wherein the PIN profile indicates one or more of a PIN state, a list of serving PEMCs, a list of serving PEGCs, a list of PIN elements, or a validity duration and a time validity of the PIN and the PIN element.

In a ninth aspect, alone or in combination with one or more of the first through eighth aspects, process 600 includes receiving, from the PEMC, a request associated with the PEGC, wherein the request is to invite the PEGC to a PIN or to expel the PEGC from the PIN; transmitting the request to the PEGC; receiving, from the PEGC, an indication that the request has been accepted; transmitting, to the PEMC, the indication that the request has been accepted; and updating a PIN profile associated with the PIN based at least in part on the request being accepted, wherein a policy and parameters are provisioned to the PEGC based at least in part on a reference point between the PIN application server and the PEGC.

In a tenth aspect, alone or in combination with one or more of the first through ninth aspects, process 600 includes receiving, from the PEMC, a request associated with the PIN element, wherein the request is to invite the PIN element to a PIN or to expel the PIN element from the PIN; transmitting the request to the PIN element; receiving, from the PIN element, an indication that the request has been accepted; transmitting, to the PEMC, the indication that the request has been accepted; and updating a PIN profile associated with the PIN based at least in part on the request being accepted, wherein a policy and parameters are provisioned to the PIN element based at least in part on a reference point between the PIN application server and the PIN element.

In an eleventh aspect, alone or in combination with one or more of the first through tenth aspects, process 600 includes provisioning, based at least in part on a policy of a mobile operator, PIN related information to a 5GC for policy control or subscription management; and transmitting, to one or more of the PEGC or the PIN element, policy and parameter update information based at least in part on provisioning the PIN related information to the 5GC.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, by a PEMC, in accordance with the present disclosure. Example process 700 is an example where the PEMC (e.g., PEMC 122) performs operations associated with registration management of PIN elements.

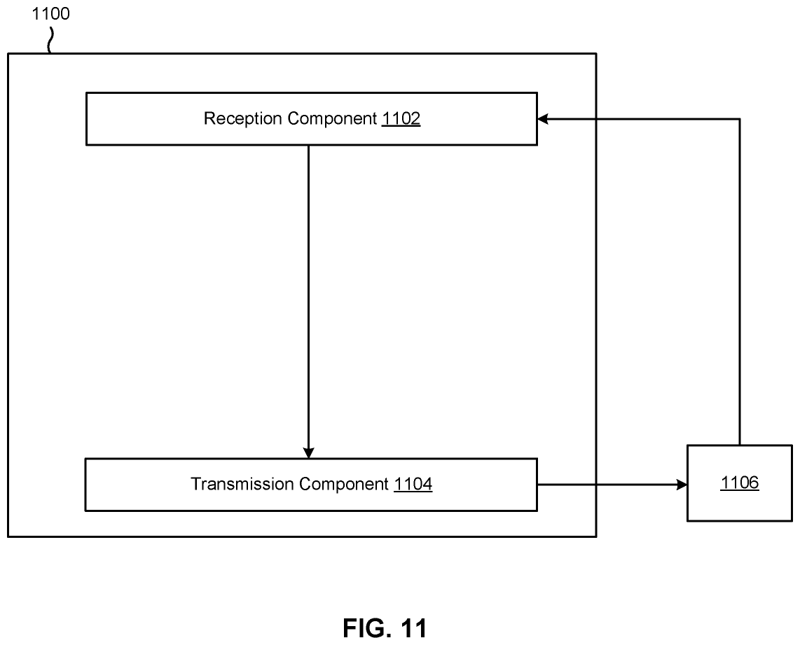

As shown in FIG. 7, in some aspects, process 700 may include communicating, to a PIN application server, signaling associated with a registration management of the PEMC (block 710). For example, the PEMC (e.g., using reception component 1102 and/or transmission component 1104, depicted in FIG. 11) may communicate, to a PIN application server, signaling associated with a registration management of the PEMC, as described above.

As further shown in FIG. 7, in some aspects, process 700 may include communicating, to the PIN application server, signaling associated with a creation of a PIN (block 720). For example, the PEMC (e.g., using reception component 1102 and/or transmission component 1104, depicted in FIG. 11) may communicate, to the PIN application server, signaling associated with a creation of a PIN, as described above.

Process 700 may include additional aspects, such as any single aspect or any combination of aspects described below and/or in connection with one or more other processes described elsewhere herein.

In a first aspect, process 700 includes transmitting, to a PEGC via the PIN application server, a request associated with the PEGC, wherein the request is to invite the PEGC to the PIN or to expel the PEGC from the PIN; and receiving, from the PEGC via the PIN application server, an indication that the request has been accepted.

In a second aspect, alone or in combination with the first aspect, process 700 includes transmitting, to a PIN element via the PIN application server, a request associated with the PIN element, wherein the request is to invite the PIN element to the PIN or to expel the PIN element from the PIN; and receiving, from the PIN element via the PIN application server, an indication that the request has been accepted.

In a third aspect, alone or in combination with one or more of the first and second aspects, process 700 includes comprises transmitting, to the PIN application server, a request to create the PIN; and receiving, from the PIN application server and based at least in part on the request, an indication of a PIN ID, wherein the PIN ID is assigned by the PIN application server to the PEMC, and the PEMC is authorized to manage the PIN.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, by a PIN element, in accordance with the present disclosure. Example process 800 is an example where the PIN element (e.g., PINE 123) performs operations associated with registration management of PIN elements.

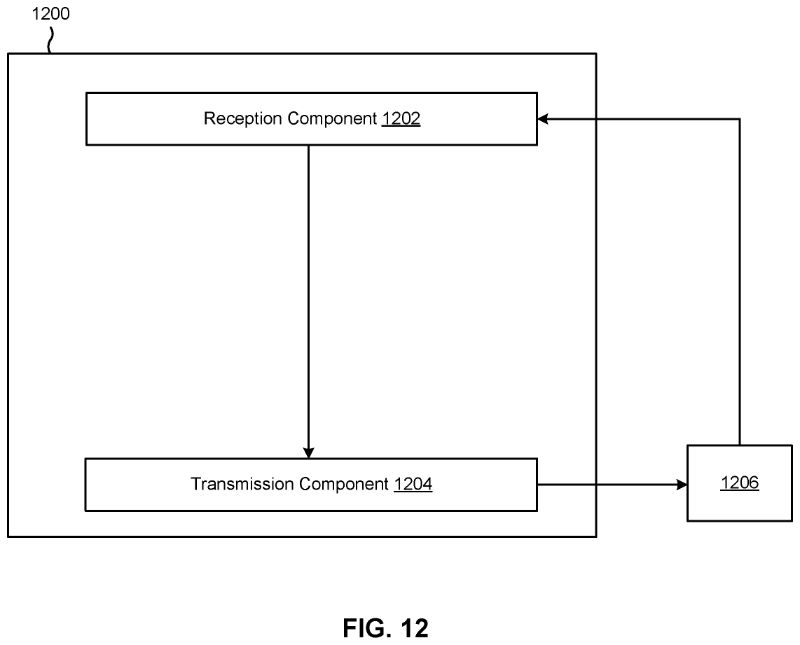

As shown in FIG. 8, in some aspects, process 800 may include communicating, to a PIN application server, signaling associated with a registration management of the PIN element (block 810). For example, the PIN element (e.g., using reception component 1202 and/or transmission component 1204, depicted in FIG. 12) may communicate, to a PIN application server, signaling associated with a registration management of the PIN element, as described above.

As further shown in FIG. 8, in some aspects, process 800 may include receiving, from a PEMC via the PIN application server, a request associated with the PIN element, wherein the request is to invite the PIN element to a PIN or to expel the PIN element from the PIN (block 820). For example, the PIN element (e.g., using reception component 1202 and/or transmission component 1204, depicted in FIG. 12) may receive, from a PEMC via the PIN application server, a request associated with the PIN element, wherein the request is to invite the PIN element to a PIN or to expel the PIN element from the PIN, as described above.

As further shown in FIG. 8, in some aspects, process 800 may include transmitting, to the PEMC via the PIN application server, an indication that the request has been accepted (block 830). For example, the PIN element (e.g., using reception component 1202 and/or transmission component 1204, depicted in FIG. 12) may transmit, to the PEMC via the PIN application server, an indication that the request has been accepted, as described above.

As further shown in FIG. 8, in some aspects, process 800 may include receiving, from the PIN application server and based at least in part on the indication that the request has been accepted, a provisioning of policy and parameter information to enforce a behavior of the PIN element (block 840). For example, the PIN element (e.g., using reception component 1202 and/or transmission component 1204, depicted in FIG. 12) may receive, from the PIN application server and based at least in part on the indication that the request has been accepted, a provisioning of policy and parameter information to enforce a behavior of the PIN element, as described above.

Process 800 may include additional aspects, such as any single aspect or any combination of aspects described below and/or in connection with one or more other processes described elsewhere herein.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a PEGC, in accordance with the present disclosure. Example process 900 is an example where the PEGC (e.g., PEGC 121) performs operations associated with registration management of PIN elements.

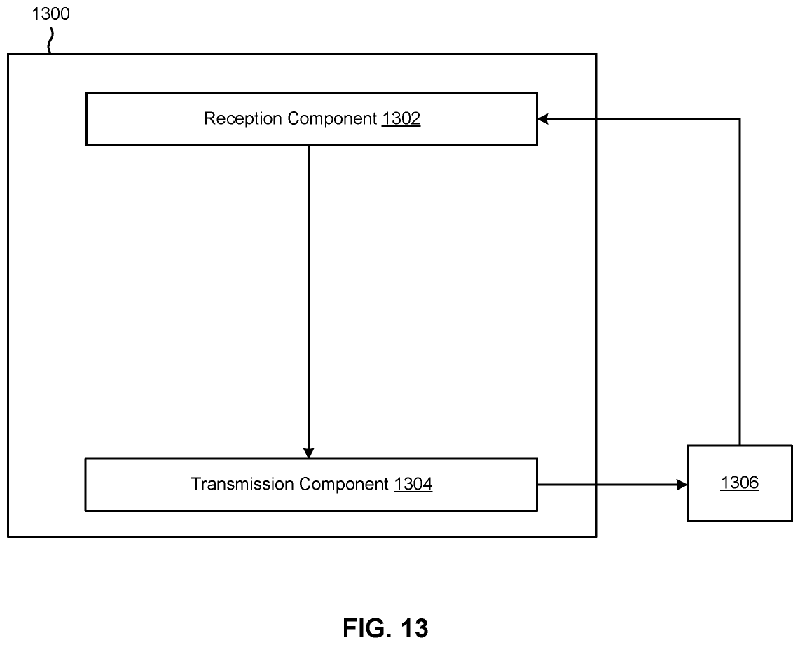

As shown in FIG. 9, in some aspects, process 900 may include communicating, to a PIN application server, signaling associated with a registration management of the PEGC (block 910). For example, the PEGC (e.g., using reception component 1302 and/or transmission component 1304, depicted in FIG. 13) may communicate, to a PIN application server, signaling associated with a registration management of the PEGC, as described above.

As further shown in FIG. 9, in some aspects, process 900 may include receiving, from a PEMC via the PIN application server, a request associated with the PEGC, wherein the request is to invite the PEGC to a PIN or to expel the PEGC from the PIN (block 920). For example, the PEGC (e.g., using reception component 1302 and/or transmission component 1304, depicted in FIG. 13) may receive, from a PEMC via the PIN application server, a request associated with the PEGC, wherein the request is to invite the PEGC to a PIN or to expel the PEGC from the PIN, as described above.

As further shown in FIG. 9, in some aspects, process 900 may include transmitting, to the PEMC via the PIN application server, an indication that the request has been accepted (block 930). For example, the PEGC (e.g., using reception component 1302 and/or transmission component 1304, depicted in FIG. 13) may transmit, to the PEMC via the PIN application server, an indication that the request has been accepted, as described above.

As further shown in FIG. 9, in some aspects, process 900 may include receiving, from the PIN application server and based at least in part on the indication that the request has been accepted, a provisioning of policy and parameter information to enforce a behavior of the PEGC (block 940). For example, the PEGC (e.g., using reception component 1302 and/or transmission component 1304, depicted in FIG. 13) may receive, from the PIN application server and based at least in part on the indication that the request has been accepted, a provisioning of policy and parameter information to enforce a behavior of the PEGC, as described above.

Process 900 may include additional aspects, such as any single aspect or any combination of aspects described below and/or in connection with one or more other processes described elsewhere herein.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram of an example apparatus 1000 for wireless communication. The apparatus 1000 may be a PIN application server, or a PIN application server may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE, a base station, or another wireless communication device) using the reception component 1002 and the transmission component 1004. As further shown, the apparatus 1000 may include a processing component 1008, among other examples.

In some aspects, the apparatus 1000 may be configured to perform one or more operations described herein in connection with FIG. 5. Additionally, or alternatively, the apparatus 1000 may be configured to perform one or more processes described herein, such as process 600 of FIG. 6. In some aspects, the apparatus 1000 and/or one or more components shown in FIG. 10 may include one or more components of the PIN application server described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the PIN application server described in connection with FIG. 2.

The transmission component 1004 may transmit communications, such as reference signals, control information, data communications, or a combination thereof, to the apparatus 1006. In some aspects, one or more other components of the apparatus 1000 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modem, a modulator, a transmit MIMO processor, a transmit processor, a controller/processor, a memory, or a combination thereof, of the PIN application server described in connection with FIG. 2. In some aspects, the transmission component 1004 may be co-located with the reception component 1002 in a transceiver.

The reception component 1002 and/or the transmission component 1004 may communicate, to one or more PIN elements, signaling associated with a registration management of the one or more PIN elements, wherein the one or more PIN elements include one or more of a PIN element, a PEGC, or a PEMC. The processing component 1008 may update a registration with the one or more PIN elements based at least in part on the registration management of the one or more PIN elements. The processing component 1008 may store or updating a profile of the one or more PIN elements based at least in part on the registration management of the one or more PIN elements.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

FIG. 11 is a diagram of an example apparatus 1100 for wireless communication. The apparatus 1100 may be a PEMC, or a PEMC may include the apparatus 1100. In some aspects, the apparatus 1100 includes a reception component 1102 and a transmission component 1104, which may be in communication with one another (for example, via one or more buses and/or one or more other components). As shown, the apparatus 1100 may communicate with another apparatus 1106 (such as a UE, a base station, or another wireless communication device) using the reception component 1102 and the transmission component 1104.

In some aspects, the apparatus 1100 may be configured to perform one or more operations described herein in connection with FIG. 5. Additionally, or alternatively, the apparatus 1100 may be configured to perform one or more processes described herein, such as process 700 of FIG. 7. In some aspects, the apparatus 1100 and/or one or more components shown in FIG. 11 may include one or more components of the PEMC described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1106. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a modem, a demodulator, a MIMO detector, a receive processor, a controller/processor, a memory, or a combination thereof, of the PEMC described in connection with FIG. 2.

The transmission component 1104 may transmit communications, such as reference signals, control information, data communications, or a combination thereof, to the apparatus 1106. In some aspects, one or more other components of the apparatus 1100 may generate communications and may provide the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, a modem, a modulator, a transmit MIMO processor, a transmit processor, a controller/processor, a memory, or a combination thereof, of the PEMC described in connection with FIG. 2. In some aspects, the transmission component 1104 may be co-located with the reception component 1102 in a transceiver.

The reception component 1102 and/or the transmission component 1104 may communicate, to a PIN application server, signaling associated with a registration management of the PEMC. The reception component 1102 and/or the transmission component 1104 may communicate, to the PIN application server, signaling associated with a creation of a PIN.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

FIG. 12 is a diagram of an example apparatus 1200 for wireless communication. The apparatus 1200 may be a PIN element, or a PIN element may include the apparatus 1200. In some aspects, the apparatus 1200 includes a reception component 1202 and a transmission component 1204, which may be in communication with one another (for example, via one or more buses and/or one or more other components). As shown, the apparatus 1200 may communicate with another apparatus 1206 (such as a UE, a base station, or another wireless communication device) using the reception component 1202 and the transmission component 1204.

In some aspects, the apparatus 1200 may be configured to perform one or more operations described herein in connection with FIG. 5. Additionally, or alternatively, the apparatus 1200 may be configured to perform one or more processes described herein, such as process 800 of FIG. 8. In some aspects, the apparatus 1200 and/or one or more components shown in FIG. 12 may include one or more components of the PIN element described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1206. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, a modem, a demodulator, a MIMO detector, a receive processor, a controller/processor, a memory, or a combination thereof, of the PIN element described in connection with FIG. 2.

The transmission component 1204 may transmit communications, such as reference signals, control information, data communications, or a combination thereof, to the apparatus 1206. In some aspects, one or more other components of the apparatus 1200 may generate communications and may provide the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more antennas, a modem, a modulator, a transmit MIMO processor, a transmit processor, a controller/processor, a memory, or a combination thereof, of the PIN element described in connection with FIG. 2. In some aspects, the transmission component 1204 may be co-located with the reception component 1202 in a transceiver.

The reception component 1202 and/or the transmission component may communicate, to a PIN application server, signaling associated with a registration management of the PIN element. The reception component 1202 may receive, from a PEMC via the PIN application server, a request associated with the PIN element, wherein the request is to invite the PIN element to a PIN or to expel the PIN element from the PIN. The transmission component 1204 may transmit, to the PEMC via the PIN application server, an indication that the request has been accepted. The reception component 1202 may receive, from the PIN application server and based at least in part on the indication that the request has been accepted, a provisioning of policy and parameter information to enforce a behavior of the PIN element.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

FIG. 13 is a diagram of an example apparatus 1300 for wireless communication. The apparatus 1300 may be a PEGC, or a PEGC may include the apparatus 1300. In some aspects, the apparatus 1300 includes a reception component 1302 and a transmission component 1304, which may be in communication with one another (for example, via one or more buses and/or one or more other components). As shown, the apparatus 1300 may communicate with another apparatus 1306 (such as a UE, a base station, or another wireless communication device) using the reception component 1302 and the transmission component 1304.

In some aspects, the apparatus 1300 may be configured to perform one or more operations described herein in connection with FIG. 5. Additionally, or alternatively, the apparatus 1300 may be configured to perform one or more processes described herein, such as process 900 of FIG. 9. In some aspects, the apparatus 1300 and/or one or more components shown in FIG. 13 may include one or more components of the PEGC described in connection with FIG. 2. Additionally, or alternatively, one or more components shown in FIG. 13 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1302 may receive communications, such as reference signals, control information, data communications, or a combination thereof, from the apparatus 1306. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1300. In some aspects, the reception component 1302 may include one or more antennas, a modem, a demodulator, a MIMO detector, a receive processor, a controller/processor, a memory, or a combination thereof, of the PEGC described in connection with FIG. 2.

The transmission component 1304 may transmit communications, such as reference signals, control information, data communications, or a combination thereof, to the apparatus 1306. In some aspects, one or more other components of the apparatus 1300 may generate communications and may provide the generated communications to the transmission component 1304 for transmission to the apparatus 1306. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1306. In some aspects, the transmission component 1304 may include one or more antennas, a modem, a modulator, a transmit MIMO processor, a transmit processor, a controller/processor, a memory, or a combination thereof, of the PEGC described in connection with FIG. 2. In some aspects, the transmission component 1304 may be co-located with the reception component 1302 in a transceiver.

The reception component 1302 and/or the transmission component 1304 may communicate, to a PIN application server, signaling associated with a registration management of the PEGC. The reception component 1302 may receive, from a PEMC via the PIN application server, a request associated with the PEGC, wherein the request is to invite the PEGC to a PIN or to expel the PEGC from the PIN. The transmission component 1304 may transmit, to the PEMC via the PIN application server, an indication that the request has been accepted. The reception component 1302 may receive, from the PIN application server and based at least in part on the indication that the request has been accepted, a provisioning of policy and parameter information to enforce a behavior of the PEGC.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

The following provides an overview of some Aspects of the present disclosure:

Aspect 1: A method of wireless communication performed by a personal Internet of Things (IoT) network (PIN) application server, comprising: communicating, to one or more PIN elements, signaling associated with a registration management of the one or more PIN elements, wherein the one or more PIN elements include one or more of a PIN element, a PIN element with gateway capability (PEGC), or a PIN element with management capability (PEMC); updating a registration with the one or more PIN elements based at least in part on the registration management of the one or more PIN elements; and storing or updating a profile of the one or more PIN elements based at least in part on the registration management of the one or more PIN elements.

Aspect 2: The method of Aspect 1, wherein the registration management includes a registration of the one or more PIN elements or a deregistration of the one or more PIN elements.

Aspect 3: The method of any of Aspects 1 through 2, wherein the registration management of the one or more PIN elements is based at least in part on an authentication of the one or more PIN elements and an access authorization of the one or more PIN elements.

Aspect 4: The method of any of Aspects 1 through 3, further comprising: communicating, to the one or more PIN elements, signaling associated with an updated registration management, wherein the updated registration management is: in a periodic manner for the one or more PIN elements to be reachable to the PIN application server, to update a status of the one or more PIN elements, to update a communication path associated with the one or more PIN elements, or to update capabilities or parameters of the one or more PIN elements.

Aspect 5: The method of any of Aspects 1 through 4, wherein the profile of the one or more PIN elements indicates one or more of: a device identifier (ID), a device name, a media access control address, a Bluetooth ID, a generic public subscription identifier of a user equipment, security related information, a device type, device communication capabilities, or device services capabilities.

Aspect 6: The method of any of Aspects 1 through 5, further comprising: maintaining device context data of the one or more PIN elements based at least in part on the registration management, wherein the device context data indicates one or more of: an associated PIN identifier, an indication of associated PIN elements, a device state, allocated Internet Protocol addresses, authorized communication paths, or authorized services.

Aspect 7: The method of any of Aspects 1 through 6, further comprising: communicating, to the PEMC, signaling associated with a creation of a PIN.

Aspect 8: The method of Aspect 7, wherein communicating the signaling further comprises: receiving, from the PEMC, a request to create the PIN; and transmitting, to the PEMC and based at least in part on the request, an indication of a PIN identifier (ID), wherein the PIN ID is assigned by the PIN application server to the PEMC, and wherein the PEMC is authorized to manage the PIN.

Aspect 9: The method of Aspect 8, further comprising: storing a PIN profile associated with the PIN and synchronizing the PIN profile with the PEMC, wherein the PIN profile indicates one or more of: a PIN state, a list of serving PEMCs, a list of serving PEGCs, a list of PIN elements, or a validity duration and a time validity of the PIN and the PIN element.

Aspect 10: The method of any of Aspects 1 through 9, further comprising: receiving, from the PEMC, a request associated with the PEGC, wherein the request is to invite the PEGC to a PIN or to expel the PEGC from the PIN; transmitting the request to the PEGC; receiving, from the PEGC, an indication that the request has been accepted; transmitting, to the PEMC, the indication that the request has been accepted; and updating a PIN profile associated with the PIN based at least in part on the request being accepted, wherein a policy and parameters are provisioned to the PEGC based at least in part on a reference point between the PIN application server and the PEGC.

Aspect 11: The method of any of Aspects 1 through 10, further comprising: receiving, from the PEMC, a request associated with the PIN element, wherein the request is to invite the PIN element to a PIN or to expel the PIN element from the PIN; transmitting the request to the PIN element; receiving, from the PIN element, an indication that the request has been accepted; transmitting, to the PEMC, the indication that the request has been accepted; and updating a PIN profile associated with the PIN based at least in part on the request being accepted, wherein a policy and parameters are provisioned to the PIN element based at least in part on a reference point between the PIN application server and the PIN element.

Aspect 12: The method of any of Aspects 1 through 11, further comprising: provisioning, based at least in part on a policy of a mobile operator, PIN related information to a Fifth Generation core network (5GC) for policy control or subscription management; and transmitting, to one or more of the PEGC or the PIN element, policy and parameter update information based at least in part on provisioning the PIN related information to the 5GC.

Aspect 13: A method of wireless communication performed by a personal Internet of Things (IoT) network (PIN) element with management capability (PEMC), comprising: communicating, to a PIN application server, signaling associated with a registration management of the PEMC; and communicating, to the PIN application server, signaling associated with a creation of a PIN.

Aspect 14: The method of Aspect 13, further comprising: transmitting, to a PIN element with gateway capability (PEGC) via the PIN application server, a request associated with the PEGC, wherein the request is to invite the PEGC to the PIN or to expel the PEGC from the PIN; and receiving, from the PEGC via the PIN application server, an indication that the request has been accepted.

Aspect 15: The method of any of Aspects 13 through 14, further comprising: transmitting, to a PIN element via the PIN application server, a request associated with the PIN element, wherein the request is to invite the PIN element to the PIN or to expel the PIN element from the PIN; and receiving, from the PIN element via the PIN application server, an indication that the request has been accepted.

Aspect 16: The method of any of Aspects 13 through 15, wherein communicating the signaling further comprises: transmitting, to the PIN application server, a request to create the PIN; and receiving, from the PIN application server and based at least in part on the request, an indication of a PIN identifier (ID), wherein the PIN ID is assigned by the PIN application server to the PEMC, and wherein the PEMC is authorized to manage the PIN.

Aspect 17: A method of wireless communication performed by a personal Internet of Things (IoT) network (PIN) element, comprising: communicating, to a PIN application server, signaling associated with a registration management of the PIN element; receiving, from a PIN element with management capability (PEMC) via the PIN application server, a request associated with the PIN element, wherein the request is to invite the PIN element to a PIN or to expel the PIN element from the PIN; transmitting, to the PEMC via the PIN application server, an indication that the request has been accepted; and receiving, from the PIN application server and based at least in part on the indication that the request has been accepted, a provisioning of policy and parameter information to enforce a behavior of the PIN element.

Aspect 18: A method of wireless communication performed by a personal Internet of Things (IoT) network (PIN) element with gateway capability (PEGC), comprising: communicating, to a PIN application server, signaling associated with a registration management of the PEGC; receiving, from a PIN element with management capability (PEMC) via the PIN application server, a request associated with the PEGC, wherein the request is to invite the PEGC to a PIN or to expel the PEGC from the PIN; transmitting, to the PEMC via the PIN application server, an indication that the request has been accepted; and receiving, from the PIN application server and based at least in part on the indication that the request has been accepted, a provisioning of policy and parameter information to enforce a behavior of the PEGC.

Aspect 19: An apparatus for wireless communication at a device, comprising a processor; memory coupled with the processor; and instructions stored in the memory and executable by the processor to cause the apparatus to perform the method of one or more of Aspects 1-18.

Aspect 20: A device for wireless communication, comprising a memory and one or more processors coupled to the memory, the one or more processors configured to perform the method of one or more of Aspects 1-18.

Aspect 21: An apparatus for wireless communication, comprising at least one means for performing the method of one or more of Aspects 1-18.

Aspect 22: A non-transitory computer-readable medium storing code for wireless communication, the code comprising instructions executable by a processor to perform the method of one or more of Aspects 1-18.

Aspect 23: A non-transitory computer-readable medium storing a set of instructions for wireless communication, the set of instructions comprising one or more instructions that, when executed by one or more processors of a device, cause the device to perform the method of one or more of Aspects 1-18.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. An apparatus of a personal Internet of Things (IoT) network (PIN) application server for wireless communication, comprising:
a memory; and
one or more processors, coupled to the memory, configured to:
communicate, to one or more PIN elements, signaling associated with a registration management of the one or more PIN elements, wherein the one or more PIN elements include one or more of a PIN element, a PIN element with gateway capability (PEGC), or a PIN element with management capability (PEMC);
update a registration with the one or more PIN elements based at least in part on the registration management of the one or more PIN elements; and
store or update a profile of the one or more PIN elements based at least in part on the registration management of the one or more PIN elements.

2. The apparatus of claim 1, wherein the registration management includes a registration of the one or more PIN elements or a deregistration of the one or more PIN elements.

3. The apparatus of claim 1, wherein the registration management of the one or more PIN elements is based at least in part on an authentication of the one or more PIN elements and an access authorization of the one or more PIN elements.

4. The apparatus of claim 1, wherein the one or more processors are further configured to:
communicate, to the one or more PIN elements, signaling associated with an updated registration management, wherein the updated registration management is: in a periodic manner for the one or more PIN elements to be reachable to the PIN application server, to update a status of the one or more PIN elements, to update a communication path associated with the one or more PIN elements, or to update capabilities or parameters of the one or more PIN elements.

5. The apparatus of claim 1, wherein the profile of the one or more PIN elements indicates one or more of: a device identifier (ID), a device name, a media access control address, a Bluetooth ID, a generic public subscription identifier of a user equipment, security related information, a device type, device communication capabilities, or device services capabilities.

6. The apparatus of claim 1, wherein the one or more processors are further configured to:
maintain device context data of the one or more PIN elements based at least in part on the registration management, wherein the device context data indicates one or more of: an associated PIN identifier, an indication of associated PIN elements, a device state, allocated Internet Protocol addresses, authorized communication paths, or authorized services.

7. The apparatus of claim 1, wherein the one or more processors are further configured to:
communicate, to the PEMC, signaling associated with a creation of a PIN.

8. The apparatus of claim 7, wherein the one or more processors, to communicate the signaling, are configured to:
receive, from the PEMC, a request to create the PIN; and
transmit, to the PEMC and based at least in part on the request, an indication of a PIN identifier (ID), wherein the PIN ID is assigned by the PIN application server to the PEMC, and wherein the PEMC is authorized to manage the PIN.

9. The apparatus of claim 8, wherein the one or more processors are further configured to:
store a PIN profile associated with the PIN and synchronizing the PIN profile with the PEMC, wherein the PIN profile indicates one or more of: a PIN state, a list of serving PEMCs, a list of serving PEGCs, a list of PIN elements, or a validity duration and a time validity of the PIN and the PIN element.

10. The apparatus of claim 1, wherein the one or more processors are further configured to:
receive, from the PEMC, a request associated with the PEGC, wherein the request is to invite the PEGC to a PIN or to expel the PEGC from the PIN;
transmit the request to the PEGC;
receive, from the PEGC, an indication that the request has been accepted;
transmit, to the PEMC, the indication that the request has been accepted; and
update a PIN profile associated with the PIN based at least in part on the request being accepted, wherein a policy and parameters are provisioned to the PEGC based at least in part on a reference point between the PIN application server and the PEGC.

11. The apparatus of claim 1, wherein the one or more processors are further configured to:
receive, from the PEMC, a request associated with the PIN element, wherein the request is to invite the PIN element to a PIN or to expel the PIN element from the PIN;
transmit the request to the PIN element;
receive, from the PIN element, an indication that the request has been accepted;
transmit, to the PEMC, the indication that the request has been accepted; and
update a PIN profile associated with the PIN based at least in part on the request being accepted, wherein a policy and parameters are provisioned to the PIN element based at least in part on a reference point between the PIN application server and the PIN element.

12. The apparatus of claim 1, wherein the one or more processors are further configured to:
provision, based at least in part on a policy of a mobile operator, PIN related information to a Fifth Generation core network (5GC) for policy control or subscription management; and
transmit, to one or more of the PEGC or the PIN element, policy and parameter update information based at least in part on provisioning the PIN related information to the 5GC.

13. An apparatus of a personal Internet of Things (IoT) network (PIN) element with management capability (PEMC) for wireless communication, comprising:
a memory; and
one or more processors, coupled to the memory, configured to:
communicate, to a PIN application server, signaling associated with a registration management of the PEMC; and
communicate, to the PIN application server, signaling associated with a creation of a PIN.

14. The apparatus of claim 13, wherein the one or more processors are further configured to:
transmit, to a PIN element with gateway capability (PEGC) via the PIN application server, a request associated with the PEGC, wherein the request is to invite the PEGC to the PIN or to expel the PEGC from the PIN; and
receive, from the PEGC via the PIN application server, an indication that accepts the request associated with the PEGC.

15. The apparatus of claim 13, wherein the one or more processors are further configured to:
transmit, to a PIN element via the PIN application server, a request associated with the PIN element, wherein the request is to invite the PIN element to the PIN or to expel the PIN element from the PIN; and
receive, from the PIN element via the PIN application server, an indication that accepts the request associated with the PIN element.

16. The apparatus of claim 13, wherein the one or more processors, when communicating the signaling, are further configured to:
transmit, to the PIN application server, a request to create the PIN; and
receive, from the PIN application server and based at least in part on the request, an indication of a PIN identifier (ID), wherein the PIN ID is assigned by the PIN application server to the PEMC, and wherein the PEMC is authorized to manage the PIN.

17. (canceled)

18. (canceled)

19. A method of wireless communication performed by a personal Internet of Things (IoT) network (PIN) application server, comprising:
communicating, to one or more PIN elements, signaling associated with a registration management of the one or more PIN elements, wherein the one or more PIN elements include one or more of a PIN element, a PIN element with gateway capability (PEGC), or a PIN element with management capability (PEMC);
updating a registration with the one or more PIN elements based at least in part on the registration management of the one or more PIN elements; and
storing or updating a profile of the one or more PIN elements based at least in part on the registration management of the one or more PIN elements.

20. The method of claim 19, wherein the registration management includes a registration of the one or more PIN elements or a deregistration of the one or more PIN elements.

21. The method of claim 19, wherein the registration management of the one or more PIN elements is based at least in part on an authentication of the one or more PIN elements and an access authorization of the one or more PIN elements.

22. The method of claim 19, further comprising:
communicating, to the one or more PIN elements, signaling associated with an updated registration management, wherein the updated registration management is: in a periodic manner for the one or more PIN elements to be reachable to the PIN application server, to update a status of the one or more PIN elements, to update a communication path associated with the one or more PIN elements, or to update capabilities or parameters of the one or more PIN elements.

23. The method of claim 19, wherein the profile of the one or more PIN elements indicates one or more of: a device identifier (ID), a device name, a media access control address, a Bluetooth ID, a generic public subscription identifier of a user equipment, security related information, a device type, device communication capabilities, or device services capabilities.

24. The method of claim 19, further comprising:
maintaining device context data of the one or more PIN elements based at least in part on the registration management, wherein the device context data indicates one or more of: an associated PIN identifier, an indication of associated PIN elements, a device state, allocated Internet Protocol addresses, authorized communication paths, or authorized services.

25. The method of claim 19, further comprising:
communicating, to the PEMC, signaling associated with a creation of a PIN.

26. The method of claim 25, wherein communicating the signaling further comprises:
receiving, from the PEMC, a request to create the PIN; and
transmitting, to the PEMC and based at least in part on the request, an indication of a PIN identifier (ID), wherein the PIN ID is assigned by the PIN application server to the PEMC, and wherein the PEMC is authorized to manage the PIN.

27. The method of claim 26, further comprising:
storing a PIN profile associated with the PIN and synchronizing the PIN profile with the PEMC, wherein the PIN profile indicates one or more of: a PIN state, a list of serving PEMCs, a list of serving PEGCs, a list of PIN elements, or a validity duration and a time validity of the PIN and the PIN element.

28. The method of claim 19, further comprising:
receiving, from the PEMC, a request associated with the PEGC, wherein the request is to invite the PEGC to a PIN or to expel the PEGC from the PIN;
transmitting the request to the PEGC;
receiving, from the PEGC, an indication that the request has been accepted;
transmitting, to the PEMC, the indication that the request has been accepted; and
updating a PIN profile associated with the PIN based at least in part on the request being accepted, wherein a policy and parameters are provisioned to the PEGC based at least in part on a reference point between the PIN application server and the PEGC.

29. The method of claim 19, further comprising:
receiving, from the PEMC, a request associated with the PIN element, wherein the request is to invite the PIN element to a PIN or to expel the PIN element from the PIN;
transmitting the request to the PIN element;
receiving, from the PIN element, an indication that the request has been accepted;
transmitting, to the PEMC, the indication that the request has been accepted; and
updating a PIN profile associated with the PIN based at least in part on the request being accepted, wherein a policy and parameters are provisioned to the PIN element based at least in part on a reference point between the PIN application server and the PIN element.

30. The method of claim 19, further comprising:
provisioning, based at least in part on a policy of a mobile operator, PIN related information to a Fifth Generation core network (5GC) for policy control or subscription management; and
transmitting, to one or more of the PEGC or the PIN element, policy and parameter update information based at least in part on provisioning the PIN related information to the 5GC.

31. A method of wireless communication performed by a personal Internet of Things (IoT) network (PIN) element with management capability (PEMC), comprising:
communicating, to a PIN application server, signaling associated with a registration management of the PEMC; and
communicating, to the PIN application server, signaling associated with a creation of a PIN.

32. The method of claim 31, further comprising:
transmitting, to a PIN element with gateway capability (PEGC) via the PIN application server, a request associated with the PEGC, wherein the request is to invite the PEGC to the PIN or to expel the PEGC from the PIN; and
receiving, from the PEGC via the PIN application server, an indication that the request has been accepted.

33. The method of claim 31, further comprising:
transmitting, to a PIN element via the PIN application server, a request associated with the PIN element, wherein the request is to invite the PIN element to the PIN or to expel the PIN element from the PIN; and
receiving, from the PIN element via the PIN application server, an indication that the request has been accepted.

34. The method of claim 31, wherein communicating the signaling further comprises:
transmitting, to the PIN application server, a request to create the PIN; and
receiving, from the PIN application server and based at least in part on the request, an indication of a PIN identifier (ID), wherein the PIN ID is assigned by the PIN application server to the PEMC, and wherein the PEMC is authorized to manage the PIN.

35. (canceled)

36. (canceled)

37. (canceled)

38. (canceled)

39. (canceled)

40. (canceled)

41. (canceled)

42. (canceled)

43. (canceled)

44. (canceled)
